(19) United States
(12) Patent Application Publication
(10) Pub. No.: US 2012/0162201 A1
(43) Pub. Date: Jun. 28, 2012

(54) STEREOSCOPIC DISPLAY APPARATUS

(75) Inventors: Dong-Wan Choi, Yongin-city (KR); Hyo-Sang Yang, Yongin-city (KR); Byung-Chang Shim, Yongin-city (KR); Hee-Kwon Eun, Yongin-city (KR)

(73) Assignee: Samsung Mobile Display Co., Ltd., Yongin-city (KR)

(21) Appl. No.: 13/238,595

(22) Filed: Sep. 21, 2011

(30) Foreign Application Priority Data
Dec. 28, 2010 (KR) 10-2010-0137221

(51) Int. Cl. G06T 15/00

(52) U.S. Cl. 345/419

(57) ABSTRACT

A stereoscopic display apparatus is disclosed. In one embodiment, the apparatus includes: a display unit which includes left eye image areas displaying a left eye image and right eye image areas displaying a right eye image and a parallax barrier which keeps a predetermined distance from the display unit to face the display unit and includes slits transmitting light emitted from the display unit and barriers blocking the light emitted from the display unit, wherein the slits and the barriers are alternately formed at the parallax barrier. The apparatus may further include a vibrator which is combined with at least a part of the parallax barrier and expands and contracts in a direction in which the display unit emits the light.

### CROSS-REFERENCE TO RELATED PATENT APPLICATION

This application claims the benefit of Korean Patent Application No. 10-2010-0137221, filed on Dec. 28, 2010, in the Korean Intellectual Property Office, the disclosure of which is incorporated herein in its entirety by reference.

### BACKGROUND

1. Field

The described technology generally relates to a stereoscopic display apparatus, and more particularly, to a stereoscopic display apparatus capable of exhibiting an effect of generating vibrations when viewing the stereoscopic display apparatus and maintaining a stereoscopic effect although a position of a user is changed when viewing the stereoscopic display apparatus.

2. Description of the Related Technology

A stereoscopic display apparatus refers to an image display apparatus which uses stereoscopic technology to add depth information to a 2-dimensional (2D) image and allows an observer to feel a sense of 3-dimension and reality using the depth information.

In general, a 3-dimensional (3D) display apparatus which displays a 3D image uses a principle of respectively providing a pair of 2D left and right eye images to left and right eyes of an observer to generate a binocular parallax. The observer respectively recognizes left and right eye images provided from a 3D image display through retinas of both eyes to enjoy a 3D image.

A 3D display apparatus is greatly classified into a glasses type 3D display apparatus and a non-glasses type 3D display apparatus. The glasses type 3D display apparatus is divided into a polarized light filter method and a time-division method, and the non-glasses type 3D display apparatus is divided into a parallax barrier method and a lenticular method.

### SUMMARY

One aspect is a stereoscopic display apparatus capable of exhibiting an effect of generating vibrations when viewing the stereoscopic display apparatus and maintaining a stereoscopic effect although a position of a user is changed when viewing the stereoscopic display apparatus.

Another aspect is a stereoscopic display apparatus including: a display unit which includes left eye image areas displaying a left eye image and right eye image areas displaying a right eye image; a parallax barrier which keeps a predetermined distance from the display unit to face the display unit and comprises slits transmitting light emitted from the display unit and barriers blocking the light emitted from the display unit, wherein the slits and the barriers are alternately formed at the parallax barrier; and a vibrator which is combined with at least a part of the parallax barrier and expands and contracts in a direction in which the display unit emits the light.

The vibrator may include a piezoceramic material. If the piezoceramic material is supplied with one of positive and negative voltages, the piezoceramic material may expand, but if the piezoceramic material is supplied with the other one of the positive and negative voltages, the piezoceramic material may contract.

The positive and negative voltages may be alternately applied to the vibrator to vibrate the vibrator and the parallax barrier combined with the vibrator.

A distance between the display unit and the parallax barrier may be controlled by expansion and contraction motions of the vibrator in the direction in which the display unit emits the light.

If the user goes back from the stereoscopic display apparatus, the vibrator may expand in the direction in which the display units emits the light, and if the user goes toward the stereoscopic display apparatus, the vibrator may contract in the direction in which the display unit emits the light.

If the user goes back from the stereoscopic display apparatus, the distance between the display unit and the parallax barrier may increase, and if the user goes toward the stereoscopic display apparatus, the distance between the display unit and the parallax barrier may decrease.

The parallax barrier may be selectively controlled in a 2-dimensional (2D) mode and a 3-dimensional (3D) mode, wherein the 2D mode is to wholly transmit the light emitted from the display unit, and the 3D mode is to transmit parts of the light and block parts of the light to form a binocular parallax.

The parallax barrier may include a liquid crystal, wherein a part of the liquid crystal supplied with power blocks the light emitted from the display unit, and the other part of the liquid crystal not supplied with power transmits the light emitted from the display unit in the 3D mode.

The parallax barrier may include a liquid crystal, wherein the liquid crystal transmits the light emitted from the display unit in the 2D mode.

The direction in which the display unit emits the light may be vertical to a plane on which a screen is realized on the display unit.

### BRIEF DESCRIPTION OF THE DRAWINGS

FIG. 1 schematically illustrates a stereoscopic display apparatus according to an embodiment.

FIG. 2 illustrates a case where a viewer goes back a few steps when the viewer views a stereoscopic display apparatus.

FIG. 3 illustrates a case where a viewer goes forward a few steps when the viewer views a stereoscopic display apparatus.

### DETAILED DESCRIPTION

Embodiments will now be described more fully with reference to the accompanying drawings.

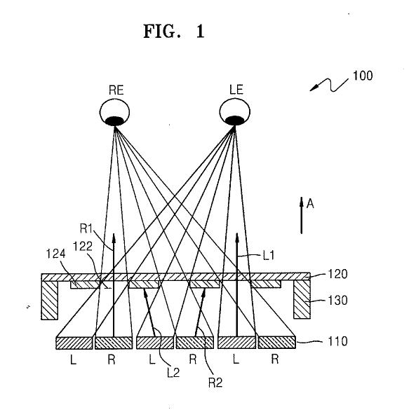

FIG. 1 schematically illustrates a stereoscopic display apparatus 100 according to an embodiment.

Referring to FIG. 1, the stereoscopic display apparatus 100 includes a display unit 110, a parallax barrier 120, and a vibrator 130.

In one embodiment, left eye image areas L and right eye image areas R are alternately formed in the display unit 110. The left eye image area L display a left eye image to be recognized by a left eye LE of a viewer, and the right eye image areas R display a right eye image to be recognized by a right eye RE of the viewer.

All types of display devices which have been developed may be used as the display unit 110. For example, the display unit 110 may be one of a cathode-ray tube (CRT), a liquid crystal display (LCD), a plasma display panel (PDP), a field emission display (FED), and an organic light-emitting device (OLED). Here, if the display unit 110 is the LCD or the like, a backlight unit (not shown) may be further installed under the display unit 110. The backlight unit emits light toward the display unit 110 using electric energy.

The parallax barrier 120 is located between the display unit 110 and the left and right eyes LE and RE of the observer to transmit or block light. The parallax barrier 120 includes slits 122 through which light emitted from the right and left eye areas R and L passes and barriers 124 which block light. Therefore, the parallax barrier 120 provides a 3D image to the observer. As seen from an enlarged plan view of the parallax barrier 120, the slits 122 and the barriers 124 are substantially vertically alternately formed.

A method of realizing a 3D image using a parallax barrier method will now be described. Parts of the light emitted from the backlight unit toward the left eye LE of the observer pass through the left eye image areas L of the display unit 110, pass through the slits 122 of the parallax barriers 120, and reach the left eye LE of the observer. However, although the parts of the light emitted from the backlight unit pass through the left eye image areas L of the display unit 100, light L2 going toward the right eye RE of the observer is blocked by the barrier 124 and thus is not transmitted to the observer.

According to the above-described method, light R1 of the light emitted from the backlight unit passes through the right eye image area R of the display unit 110, passes through the slit 122 of the parallax barrier 120, and reaches the right eye RE of the observer. Although Light R2 passes through the right eye image area R of the display unit 110 and goes toward the left eye LE of the observer, the light R2 is blocked by the barrier 124.

As a result, a part of light having passed through the left eye image area L is light L1 which transmits only to the left eye LE of the observer. A part of light having passed through the right eye image area R is light R1 which is transmitted only to the right eye RE of the observer. Therefore, the observer recognizes the light L1 and the light R1 with his left and right eyes, respectively. Here, parallax information is formed between the light L1 reaching the left eye LE so that the observer fully senses the light L1 and the light R1 reaching the right eye RE. Therefore, the observer enjoys a 3D image.

In one embodiment, the barriers 124 of the parallax barrier 120 are formed in a pattern on a predetermined film in FIG. 1. However, the parallax barrier 120 may be realized using a liquid crystal. In this case, the parallax barrier 120 may be formed to enable switching between a 2D mode and a 3D mode. For example, in the 3D mode, when power is applied to a liquid crystal, some pixels block and/or absorb light emitted from the backlight unit to operate as the barriers 124. The other pixels which are not supplied with power operate as the slits 122 of the parallax barrier 120 to realize a 3D image. In the 2D mode, when power is not applied to the liquid crystal, barriers are not formed. Therefore, all parts of light emitted from the display unit 110 pass through the parallax barrier 120 to transmit the same image to left and right eyes of a viewer so as to display a 2D image.

The vibrator 130 may be formed on at least part of the parallax barrier 120 or at an edge of the parallax barrier 120. The vibrator 130 maintains a distance between the display unit 110 and the parallax barrier 120.

Here, in the stereoscopic display apparatus 100 according to the present embodiment, the vibrator 130 is combined with the parallax barrier 120 to apply predetermined vibrations to the parallax barrier 120. This will now be described in more detail.

In a typical stereoscopic display apparatus, a distance between a display unit and a parallax barrier is generally uniformly maintained. In this case, it is not easy to give a specific effect to a screen so that a viewer feels suddenly given an external shock or running in a gravelly field. Since the distance between the display unit and the parallax barrier is uniformly maintained, a viewing position of the user is to be considered. If the viewer goes forward or backward the stereoscopic display apparatus 100, left and right eye images are mixed, thereby forming an after image.

In one embodiment, the vibrator 130 is combined with at least one side of the parallax barrier 120 to apply predetermined vibrations to the parallax barrier 120. The vibrator 130 expands or contracts in a direction in which an image is realized on the display unit 110 to adjust the distance between the display unit 110 and the parallax barrier 120.

The vibrator 130A may be formed of a piezoceramic material. When a pressure is applied to the piezoceramic material, the piezoceramic material generates a voltage. When an electric field is applied to the piezoceramic material, the piezoceramic material generates a mechanical deformation. The piezoceramic material converts mechanical vibration energy into electric energy or electric energy into mechanical vibration energy and thus has high conversion efficiency.

In more detail, Pb(Zr.Ti)O3 is one of ferroelectric materials having ferroskite type crystal structures showing great piezoelectric characteristics among piezoelectric materials. In general, PbTiO3 and PbZrO3 are used as a basic combination. However, a mixture ratio of these two components may be changed to control all characteristics such as a piezoelectric, dielectric, and elastic characteristics. The two components are relatively stable with respect to changes of peripheral environments and thus do not generate specific changes except that a curie point exists at a temperature of about 300° C. Materials having temperature coefficients corresponding to modifications have been developed.

The vibrator 130 may be formed on at least the part of the parallax barrier 120 or at the edge of the parallax barrier 120. The parallax barrier 120 may be formed to expand and contract in the direction in which the image is realized on the display unit 110, i.e., in direction A indicated with an arrow. For example, if a positive voltage (+) is applied to the vibrator 130, the vibrator 130 expands in the direction A to increase the distance between the display unit 110 and the parallax barrier 120. If a negative voltage (−) is applied to the vibrator 130, the vibrator 130 contracts in the direction A to decrease the distance between the display unit 110 and the parallax barrier 120. If the positive and negative voltages are alternately applied to the vibrator 130, the vibrator 130 repeatedly expands and contracts to vibrate the parallax barrier 120.

According to one embodiment, since a viewer feels a sudden external shock or running on a gravelly field, a vibration effect may be obtained. One embodiment may be further effectively used when games or the like are performed using a stereoscopic display apparatus.

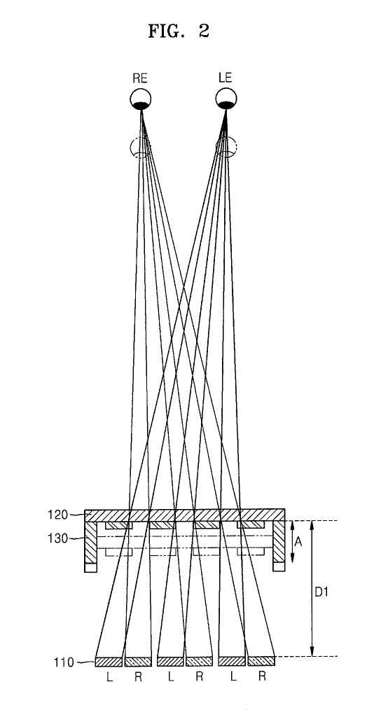

FIG. 2 illustrates a case where a viewer goes back a few steps when the viewer views the stereoscopic display apparatus of FIG. 1.

Referring to FIG. 2, if a position of the parallax barrier 120 is fixed to the display unit 110, parts of a left eye image are blocked by the barriers 124 and thus are not incident onto a left eye. Parts of a right eye image are not blocked by the barriers 124 and thus are incident onto the left eye. Parts of a right eye image are blocked by the barriers 124 and thus are not incident onto a right eye. Parts of the left eye image are not blocked by the barriers 124 and thus are incident onto the right eye. In this case, the left and right eye images are mixed, thereby degrading a 3D effect and clarity of a screen.

In one embodiment, in order to solve this, if a viewer goes backward a few steps when viewing the stereoscopic display apparatus 100, and a positive voltage is applied to the vibrator 130, the vibrator 130 expands in direction A indicated by an arrow to increase a distance D1 between the display unit 110 and the parallax barrier 120. Here, the expansion of the vibrator 130 may be adjusted to correspond to a distance by which the viewer goes backward. According to this method, the distance between the display unit 110 and the parallax barrier 120 may be adjusted to maintain a 3D effect and clarity of a screen even if the viewer moves when viewing the stereoscopic display apparatus 100.

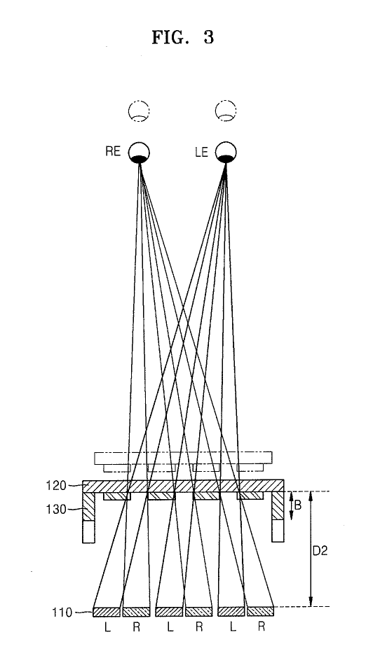

FIG. 3 illustrates a case where a viewer goes forward a few steps when the viewer views a stereoscopic display apparatus. In this case, if a position of the parallax barrier 120 is fixed to the display unit 110, parts of a left eye image are blocked by the barriers 124 and thus are not incident onto a left eye. Parts of a right eye image are not blocked by the barriers 124 and thus are incident onto the left eye. Parts of the right eye image are blocked by the barriers 124 and thus are not incident onto a right eye. Parts of the left eye image are not blocked by the barriers 124 and thus are incident onto the right eye. In this case, the left and right eye images are mixed to degrade a 3D image and clarity of a screen.

In one embodiment, in order to solve this, if a viewer goes forward a few steps when viewing the stereoscopic display apparatus 100, and a negative voltage is applied to the vibrator 130, the vibrator 130 contracts in direction B indicated by an arrow to decrease a distance D2 between the display unit 110 and the parallax barrier 120. Here, the expansion of the vibrator 130 may be adjusted to correspond to a distance by which the viewer goes backward. Here, the contraction of the vibrator 130 may be adjusted to correspond to a distance by which the viewer goes backward. According to this method, the distance between the display unit 110 and the parallax barrier 120 may be adjusted to maintain a 3D effect and clarity of a screen even if the viewer moves when viewing the stereoscopic display apparatus 100.

As described above, according to at least one of the disclosed embodiments, an effect of generating vibrations when viewing a stereoscopic display apparatus may be obtained. Although a position of a viewer is changed, a 3D effect may be uniformly maintained.

While certain embodiments have been described with reference to the accompanying drawings, it will be understood by those of ordinary skill in the art that various changes in form and details may be made therein without departing from the spirit and scope of the following claims.

What is claimed is:

1. A stereoscopic display apparatus comprising:
a display unit comprising i) left eye image areas configured to display a left eye image and ii) right eye image areas configured to display a right eye image;
a parallax barrier spaced apart from and facing the display unit, wherein the parallax barrier comprises i) slits configured to transmit light emitted from the display unit and ii) barriers configured to block the light emitted from the display unit, and wherein the slits and the barriers are alternately formed at the parallax barrier; and
a vibrator connected to at least part of the parallax barrier and configured to expand and contract in a direction in which the display unit emits the light.

2. The stereoscopic display apparatus of claim 1, wherein the vibrator is formed of a piezoceramic material.

3. The stereoscopic display apparatus of claim 2, wherein the piezoceramic material is configured to expand based on one of positive and negative voltages, and wherein the piezoceramic material is configured to contract based on the other voltage.

4. The stereoscopic display apparatus of claim 3, wherein the vibrator is configured to alternatively receive the positive and negative voltages such that the vibrator and the parallax barrier vibrate.

5. The stereoscopic display apparatus of claim 1, wherein the vibrator is configured to control the distance between the display unit and the parallax barrier based on its expansion and contraction motions.

6. The stereoscopic display apparatus of claim 1, wherein the vibrator is configured to expand when the user goes back from the stereoscopic display apparatus, and wherein the vibrator is configured to contract when the user goes toward the stereoscopic display apparatus.

7. The stereoscopic display apparatus of claim 1, wherein if the user goes back from the stereoscopic display apparatus, the distance between the display unit and the parallax barrier increases, and wherein if the user goes toward the stereoscopic display apparatus, the distance between the display unit and the parallax barrier decreases.

8. The stereoscopic display apparatus of claim 1, wherein the stereoscopic display apparatus is configured to selectively control the parallax barrier in a 2-dimensional (2D) mode and a 3-dimensional (3D) mode, wherein the 2D mode is to transmit substantially the entire light emitted from the display unit, and wherein the 3D mode is to partially transmit and partially block the light to form a binocular parallax.

9. The stereoscopic display apparatus of claim 8, wherein the parallax barrier comprises a liquid crystal, wherein a portion of the liquid crystal supplied with power is configured to block the light emitted from the display unit, and wherein the remaining portion of the liquid crystal not supplied with power is configured to transmit the light emitted from the display unit in the 3D mode.

10. The stereoscopic display apparatus of claim 8, wherein the parallax barrier comprises a liquid crystal, and wherein the liquid crystal is configured to transmit the light emitted from the display unit in the 2D mode.

11. The stereoscopic display apparatus of claim 1, wherein the direction in which the display unit emits the light is substantially vertical to a plane on which an image is displayed.
